(19) United States
(12) Patent Application Publication
(10) Pub. No.: US 2007/0245972 A1
(43) Pub. Date: Oct. 25, 2007

(54) Barriers or partitions

(76) Inventor: Paul S. Symons, Cornwall (GB)

Correspondence Address: GIFFORD, KRASS, SPRINKLE,ANDERSON & CITKOWSKI, P.C, PO BOX 7021, TROY, MI, 48007-7021, US

(21) Appl. No.: 11/465,133

(22) Filed: Aug. 17, 2006

(30) Foreign Application Priority Data
Aug. 20, 2005 (GB) 0517130.1

(51) Int. Cl. E04H 17/16; A01K 63/00

(52) U.S. Cl. 119/255

(57) ABSTRACT

A barrier having at least one panel. The barrier is interlocked directly with an adjacent panel to provide a continuous uninterrupted face.

### FIELD OF THE INVENTION

This application relates to improvements in barriers or partitions such as fencing, hoardings, internal walls, dividing walls etc.

### BACKGROUND OF THE INVENTION

There are many situations where it is necessary to provide a temporary secure compound in the open air. For example, building sites often require a compound to keep the general public out for both safety reasons and for security reasons. Such compounds typically comprise fencing and a gateway. The fencing in such situations is often referred to as hoarding, and is composed of a series of individual units.

Such hoardings may be made of various different materials, including plastics, wood or metal, particularly steel. Whether in mesh, slat or sheet form metal hoarding is difficult to erect due to its weight, and the number of components required. Further, hoarding units are usually supported between posts which are themselves supported by relatively large base units. Accordingly, the base units very often hold the hoarding units spaced from the ground and thus a gap is often left which compromises the security of the barrier.

Wooden hoardings, by contrast, are much lighter and more economical. Typically these comprise wooden units fixed to wooden posts which have previously been set in the ground. This overcomes the problem of the gap beneath each unit but presents a different problem in that they are not re-usable and are usually disposed of after use. This means that they have to be made and assembled individually for each construction site which increases the cost and the amount of material involved.

### SUMMARY OF THE INVENTION

In one aspect the invention provides a barrier or partition unit comprising at least one panel and means for interlocking directly with an adjacent such hoarding unit to present a substantially uninterrupted facade.

Advantageously the barrier or partition units may be so formed that no separate post is required between adjacent units to support the unit(s) and therefore no gap is left between each unit. Likewise, it is preferred for the barrier or partition to be constructed in such a way that there is no need for a base unit so that each barrier or partition unit may be placed close to or even flush with the ground surface. This improves security.

In one embodiment, the barrier or partition unit has a frame supporting the panel. This frame provides rigidity to the panel and can protect the panel from damage during transit, erection and use. It also provides rigidity to the barrier or partition when several such units are assembled together.

The means for interlocking adjacent units may be in the form of male and female connectors. The female connectors may conveniently take the form of channels or grooves and the male connectors may be tongues or ridges, which in the simplest form may simply be the edge of the frame and/or panel. These features are simple to provide and easy to use and allow for versatility in that a hoarding or barrier made from a series of such barrier or partition units can be erected in a curve as well as a straight line.

In yet another embodiment, an additional frame element is provided to strengthen the barrier or partition unit at points of weakness, for instance where two panels meet on the same frame.

Further embodiments are described in the dependent Claims attached hereto.

### BRIEF DESCRIPTION OF THE DRAWINGS

The present invention will be further described and explained with reference to the accompanying drawings in which:

FIG. 1 is a frontal view showing the front face of a hoarding unit formed as a first embodiment of the invention;

FIG. 2 is a plan view of the unit of FIG. 1;

FIG. 3 is a perspective view of the hoarding unit of FIGS. 1 and 2 from the rear and one side;

FIG. 4 is a plan view of a hoarding unit formed as a second embodiment of the invention;

FIG. 5 is a perspective view of a hoarding unit formed as a third embodiment of the invention;

FIG. 6 is a perspective view of a series of hoarding units formed as a fourth embodiment of the invention;

FIG. 7 is a plan view of a series of hoarding units according to the first, third or fourth embodiments of the invention;

FIG. 8 is another plan view of a series of hoarding units according to the first, third or fourth embodiments of the invention;

FIG. 9 is a perspective view of a hoarding unit formed as a fifth embodiment of the invention;

FIG. 10 is a perspective view of a series of hoarding units formed as a sixth embodiment of the invention;

FIG. 11 is a perspective view of a stabiliser suitable for use with embodiments of the invention; and

FIG. 12 is a perspective view of a series of hoarding units according to the third embodiment of the invention interconnected and supported by stabilisers.

### DETAILED DESCRIPTION OF THE INVENTION

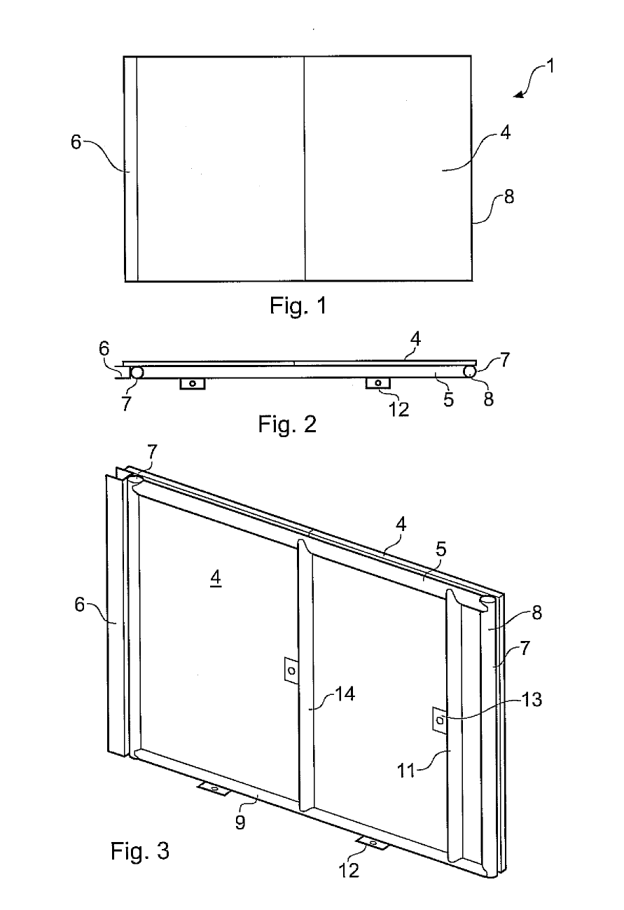

Referring now to the drawings FIG. 1 is a view of a hoarding unit 1, according to the first embodiment of the invention, comprising two adjacent panels 4, the unit having a male connector 8 and a female connector 6 at respective opposite edges thereof.

FIGS. 2 and 3 show the two adjacent panels 4 supported by a frame. The frame comprises a top element 5, two side elements 7 and a bottom element 9 held together in a rectangular shape. The female connector 6 is a channel-shape element dimensioned to fit around a male connector 6 on an adjacent hoarding 1. The female connector 6 is fixed along the length of one side element 7 of the frame. Although the female connector 6 is shown as extending the full height of the panel 4 it does not have to be this long. Further, it does not have to be only one connector as will be explained in more detail below.

The male connector 8 in this embodiment is the other side element 7 of the frame opposite to the side element 7 which has the female connector.

In the embodiment shown in FIGS. 1 to 3 two panels 4 are shown in the one hoarding unit 1. In such a situation it is possible to have an additional element 14 fixed to the frame and positioned immediately behind the junction between the two panels 4 so that it extends between the top element 5 and bottom element 9. This additional frame element 14 strengthens the naturally occurring weak point in the hoarding unit due to the junction between the two adjacent panels 4. Such strengthening eliminates the possibility of unauthorised access being gained to the compound via the weak point, such as by forcing the panels 4 inwards.

Although two panels 4 are shown it is also contemplated to have only one or indeed more than two panels 4 per hoarding unit 1. Additional frame elements 14, 11 may then be positioned accordingly. Further, if the junction between two panels were to extend horizontally (with respect to the hoarding units shown in the Figures) the additional frame elements may be positioned horizontally so that they extend between the two side elements 7 and support the horizontal junction between adjacent panels 4. Such horizontally positioned additional frame elements may of course also serve to provide extra rigidity.

In addition to the additional element 14, FIG. 3 also shows another additional frame element 11. This can be included to provide further protection and strength to an additional junction between face panels 4, to provide extra rigidity to the frame, or as a point at which the hoarding can be stabilised/supported.

In the Figures, the elements 5, 7 and 9 are shown as tube-like members, although members with cross-sectional shapes other than circular are of course possible.

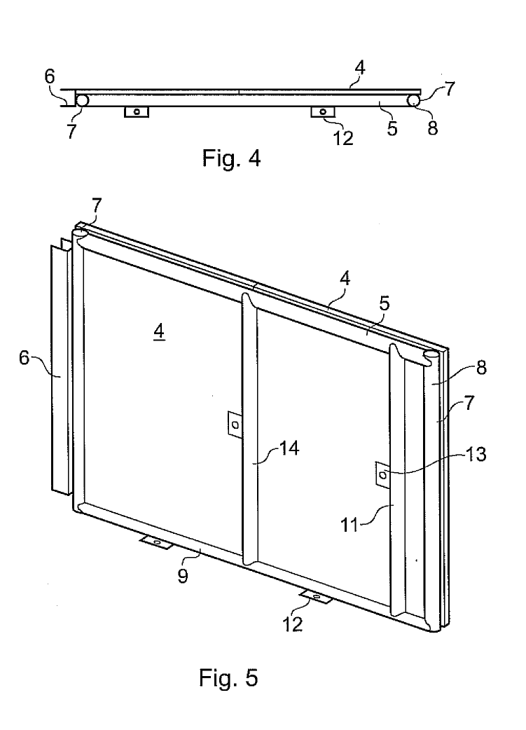

FIG. 4 is a plan view of a second embodiment of the invention. It shows a hoarding unit similar to the one shown in FIGS. 1 to 3 and described above. However, it differs in that the male connector 8 is comprised of both the side element 7 and the panel 4. Accordingly, the female connector 6 is dimensioned so that it is wide enough to fit around this male connector 8. A series of such hoarding units would provide a substantially improved barrier in that each unit would overlap with its adjacent unit to present a facade with no gaps between adjacent units. It is also possible to provide a barrier or series of hoarding units in a curve shape (as viewed in plan) with a relatively large angle of radius.

FIG. 5 is a perspective view of a third embodiment of the invention. It has the same features as the hoarding unit 1 of the first embodiment except that the female connector 6 lies along the side element 7 of the frame but only between the top 5 and bottom elements 9 of the frame. The female connector 6 is dimensioned so that it fits around the male connector 8 which comprises the side element 7 of the frame. However, the female connector 6 does not have to be one continuous channel-like element but may in fact comprise of more than one element.

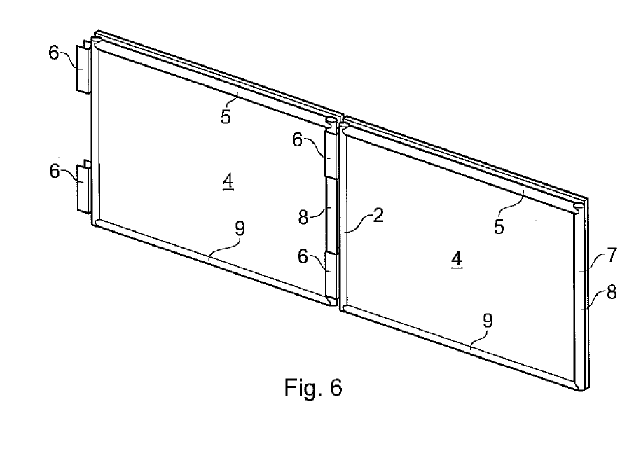

In a fourth embodiment, FIG. 6 is a perspective view of two such hoarding units where it is seen that there are in fact two female connectors 6 at each side of each unit. However, it should be noted that the female connectors 6 only lie between the top 5 and bottom 9 elements of the frame.

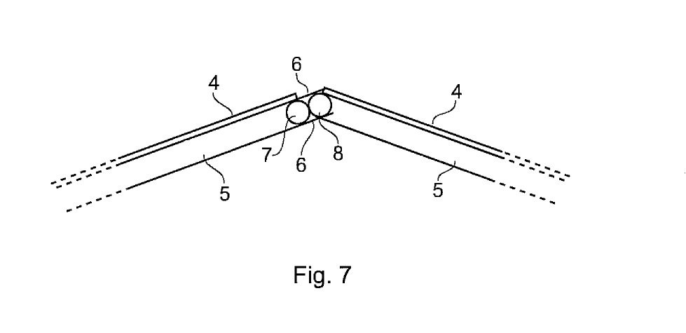

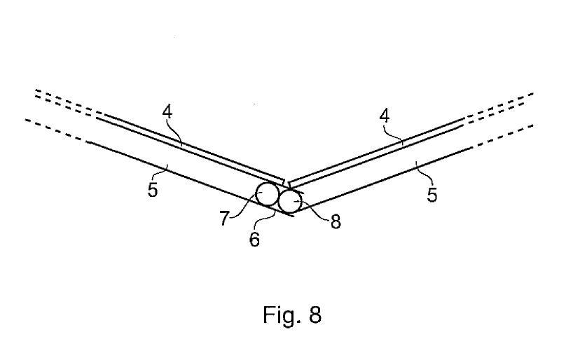

By this arrangement of female connectors 6, two adjacent hoarding units may be interconnected at angles to one another (as viewed from above). A better understanding of this concept may be had by viewing FIGS. 7 and 8.

FIG. 7 is a plan view of an external corner where two adjacent hoarding units have been placed at an angle to one another. It will be seen that the female connector 6 of the left hand hoarding extends around the male connector 8 of the right hand hoarding. FIG. 8, on the other hand, is a plan view of an internal corner. There are obvious benefits to hoarding units which can be positioned adjacent to one another in this manner. For instance, it is possible to provide a barrier which is flexible enough to extend around pre-existing objects such as trees or other features.

In addition to the arrangement of hoarding units shown in FIGS. 7 and 8 being examples of the invention according to the fourth embodiment of FIG. 6, it will be seen that they may also be examples of the third embodiment of FIG. 5 and the first embodiment of FIGS. 1 to 3. With respect to the first embodiment, to ensure that the female connector 6 may fit around the male connector 8 with two adjacent hoarding units lying at an appropriate angle to one another a gap would have to be maintained between the panel 4 and the male connector 8/side element 7 of the frame, or the panel 4 would have to be arranged so that it did not extend across the male connector 8/side element 7.

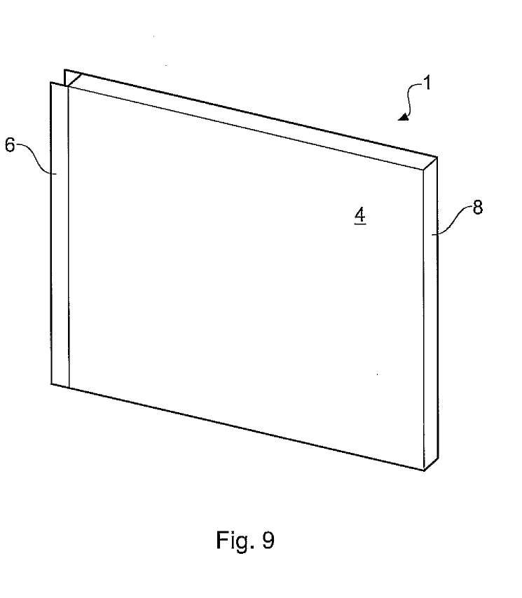

FIG. 9 is a perspective view of a fifth embodiment of the invention. It shows a hoarding unit 1 comprising a panel 4. In this embodiment there is no separate frame as such. The male connector 8 may be seen to be merely the edge of the panel 4 and the female connector 6 is similar to that shown in the previous embodiments and is dimensioned to fit around the male connector 8.

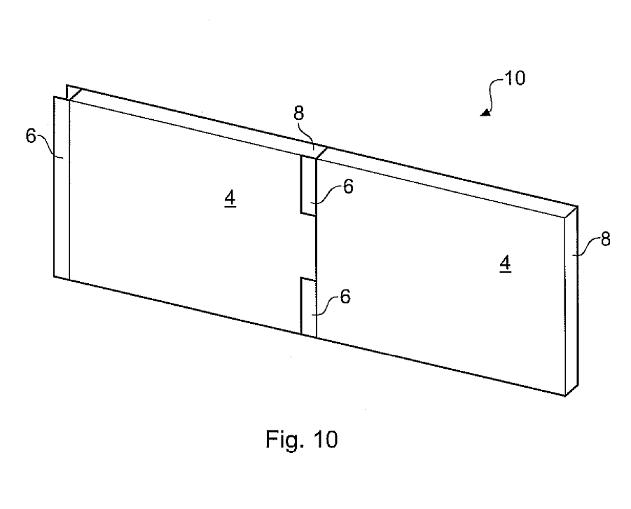

In a sixth embodiment, FIG. 10 is a perspective view of a series 10 of two adjacent hoarding units. The unit on the left is a unit as described and shown above with reference to the fifth embodiment. However, the unit on the right has an alternative female connector in that rather than one continuous channel-shaped element lying along one edge of the panel 4, there are two separate channel-shaped elements. It is contemplated that there may be any suitable number of elements malting up the female connector 6.

Returning briefly to FIG. 3 base plates 12 and brackets 13 are also shown. The brackets 13 are shown attached to, or as part of, the additional frame elements 10, 11. However, they could equally be attached to, or part of, the frame elements 7 or 8. The purpose of these brackets 13 will be explained in more detail below. The base plates 12 are shown attached to, or as part of, the bottom element 9. More details on these will also be discussed below.

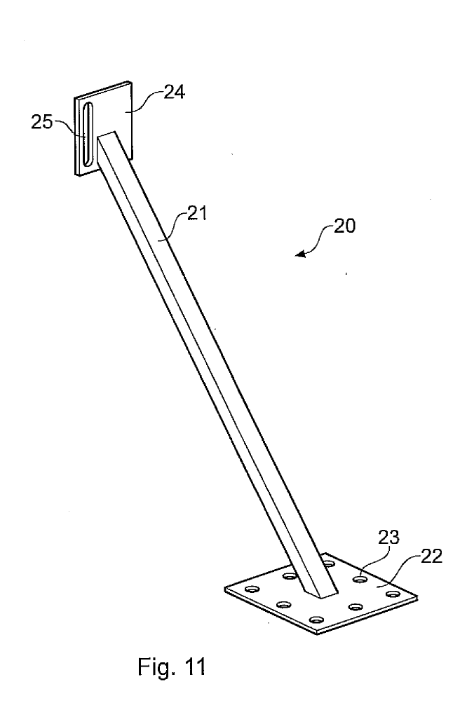

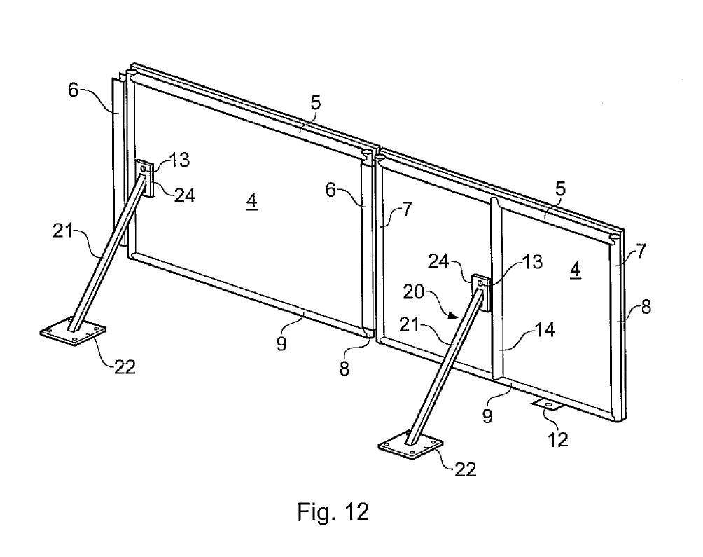

FIG. 11 is a perspective view of a stabiliser 20. This stabiliser comprises a leg 21 attached to a base plate 22 at its lower end and a head plate 24 at its upper end. Head plate 24 has a slot 25 cut therethrough. The base 22 and head 24 plates are arranged so that they lie with their surfaces at right angles to one another. They are arranged so that in use the head plate 24 may be fixed to a bracket 13 of a substantially vertical hoarding and the base plate 22 may be fixed to a substantially horizontal ground surface.

With reference to FIG. 12, a first hoarding unit is held upright and a stabiliser 20 is positioned against it with the head plate 24 located adjacent and against bracket 13 and the base plate 22 on the ground. Bracket 13 and slot 25 are then fixed together, for example with a nut and bolt. The base plate 22 is fixed to the ground by driving fixing means through holes 23. Further anchoring of the hoarding unit to the ground may be carried out by means of driving fixing means through the holes in base plates 12 which are attached to the bottom element 9 of the frame. If necessary additional stabilisers are used.

Another hoarding unit is then placed adjacent to the first hoarding unit so that the male 8 and female connectors 6 interconnect. Stabiliser(s) 20 are then fixed into place to support the hoarding, if necessary. This sequence is repeated until the desired length of hoarding has been erected.

It will be noted that the hoarding units are flush with the ground surface. This provides better security than otherwise.

With regard to the fixing means used with base plates 12, 22, such means could comprise of smooth metal pins, threaded ground screws, expansion bolts, or resin-anchor bolts etc. However, for indoor use where it might not be desirable to fix the base plate to the floor alternative means such as the use of weights or larger base plates 12, 22 are of course possible.

With regard to all of the relevant embodiments, the frame 6 and additional frame elements 10, 11 may be fabricated from tubular steel and the panels 4 from timber, such as sheets of wood (e.g. plywood). Such a construction ensures that the overall weight of the hoarding is relatively light, compared to an all steel construction, and yet hard wearing compared to an all timber construction. However, rather than tubular steel, box steel or even channel steel could of course be employed. Alternatively, other materials such as recycled plastics may be used.

With regard to the stabiliser 20, this could be made from many different types of materials. For instance, the stabiliser 20 could be fabricated from steel plate and channels, from timber, from recycled plastics, or from a combination of steel, timber and plastic.

A temporary hoarding in accordance with the present invention is both hard wearing and relatively light weight and is relatively quick and easy to erect and dismantle.

The hoardings can be made up in different sizes so as to provide a suitable overall length.

With regard to the male connectors 8, they have been described as either the side element 7 of the frame and/or the edge of the panel 4. However, if necessary an additional element may be fitted to the edge of the panel/frame element to act either alone or in combination as the male connector 8. This may be useful in that this additional element could be a replaceable wear-part.

1. A barrier or partition unit comprising at least one panel, and means for interlocking directly with an adjacent barrier or partition unit so as to provide a continuous uninterrupted face.

2. A barrier or partition unit according to claim 1, further comprising a frame for supporting the at least one panel.

3. A barrier or partition unit according to claim 1, wherein the means for interlocking with an adjacent barrier or partition unit comprises at least one of each male and female connectors.

4. A barrier or partition unit according to claim 3, wherein the at least one male connector is provided on one edge of the barrier or partition unit and the at least one female connector is provided on an opposite edge of the barrier or partition unit.

5. A barrier or partition unit according to claim 3, wherein the at least one female connector comprises a channel.

6. A barrier or partition unit according to claim 3, wherein the at least one male connector comprises an edge of the panel or frame.

7. A barrier or partition unit according to claim 2, further comprising at least two panels adjacently attached to the frame, wherein the frame further comprises at least one additional frame element positioned so as to overlap the junction between the adjacent panels on one side.

8. A barrier or partition unit according to claim 1, further comprising at least one bracket for connection to a stabiliser.

9. A barrier or partition unit according to claim 8, further comprising at least one stabiliser for connection to the at least one bracket.

10. A barrier or partition unit according to claim 9, wherein the at least one stabiliser has a base plate for fixing to a ground surface and a head plate for fixing to the at least one bracket.

11. A barrier or partition unit according to claim 1, further comprising at least one base plate for fixing to a ground surface.

12. A barrier or partition unit according to claim 2, wherein the frame is fabricated from tubular steel and the panel(s) from wood.

13. A series of barrier or partition units according to claim 1, which when erected and supported in place the bottom edge thereof is flush with the underlying ground surface.

14. A hoarding comprising a plurality of hoarding units as claimed in claim 1 interlocked together.
